(19) United States
(12) Patent Application Publication
(10) Pub. No.: US 2025/0202878 A1
(43) Pub. Date: Jun. 19, 2025

(54) SYSTEMS, METHODS, AND COMPONENTS ASSOCIATED WITH ACCESS POINT NETWORK CONNECTIVITY

(71) Applicant: THE CHAMBERLAIN GROUP LLC, OAK BROOK, IL (US)

(72) Inventors: Eric Likson Chan, Naperville, IL (US); Weiying Cheng, Naperville, IL (US)

(21) Appl. No.: 18/952,364

(22) Filed: Nov. 19, 2024

Related U.S. Application Data
(60) Provisional application No. 63/609,632, filed on Dec. 13, 2023.

(51) Int. Cl. H04L 9/40; H04L 67/141

(52) U.S. Cl. CPC H04L 63/08; H04L 67/141

(57) ABSTRACT

Systems, methods, and devices are provided for establishing network connection for an endpoint device. A method of establishing network connection for an endpoint device can include detecting, by an endpoint device comprising one or more processors, a gateway device in proximity to the endpoint device; receiving, at the endpoint device, a device ID of the gateway device; computing, by the endpoint device, a passcode prediction associated with the gateway device based on the device ID of the gateway device; and transmitting the passcode prediction to the gateway device to access the network.

### CROSS-REFERENCE TO RELATED APPLICATIONS

The present application claims priority to U.S. Provisional Patent Application 63/609,632 filed on Dec. 13, 2023, the disclosure of which is incorporated by reference herein in its entirety.

### FIELD

The present disclosure relates generally to establishing network connectivity for one or more endpoint devices.

### BACKGROUND

Movable barriers are often used in secured environments, such as warehouses and loading docks, to provide selective access to the secured environment. For example, shipping warehouses typically include a plurality of loading docks each selectively closed by a movable barrier. During installation, each movable barrier is set up and configured, which typically entails an action or actions by an end-user or installer/technician to either manually program a movable barrier operator associated with the movable barrier or manually connect the movable barrier operator to a network for at least one of remote monitoring and remote control. For large facilities where multiple devices must be set up, such as loading docks having multiple movable barrier operators, each device (e.g., each movable barrier operator) must be individually set up and configured to integrate into the facility ecosystem of products. This takes significant time to complete, resulting in high installation and set up costs, increased chance of improper setup, opportunities for third party attackers to gain access to the devices as a part of prolonged set up durations (which might ultimately reduce facility security), and other problems.

Accordingly, improved systems and methods of automating connectivity between the devices and facility is desired. In particular, systems and methods which allow for quick installation and set up of facility devices is desired.

### BRIEF DESCRIPTION

Aspects of the invention in accordance with the present disclosure will be set forth in part in the following description, or may be readily implied or understood from the description, or may be learned through practice of the technology.

One example aspect of the present disclosure is directed to a computer-implemented method. The method includes detecting, by an endpoint device comprising one or more processors, a gateway device in proximity to the endpoint device. The method includes receiving, at the endpoint device, a device ID of the gateway device. The method includes computing, by the endpoint device, a passcode prediction associated with the gateway device based on the device ID of the gateway device. The method includes transmitting the passcode prediction to the gateway device to access the network.

Another example aspect of the present disclosure is directed to a computer-implemented method. The method includes computing, by a gateway device instantiating connection to a network, a passcode for the gateway device based on a device ID of the gateway device. The method includes receiving, at the gateway device, a signal descriptive of a passcode prediction computed by an endpoint device. The method includes comparing, via the gateway device, the passcode computed by the gateway device and the passcode prediction of the endpoint device. The method includes instantiating, via the gateway device, the endpoint device with access to the network based on the comparison.

Another example aspect of the present disclosure is directed to a gateway device for establishing network connection for an endpoint device. The gateway device includes a network interface comprising one or more communication protocols configured to be communicatively coupled to a network. The gateway device includes a local interface comprising a wireless communication protocol configured to be communicatively coupled to an endpoint device. The gateway device includes firmware including instructions configured for determining a passcode for the gateway device. The gateway device includes a processor. The processor is configured to compute a passcode for the wireless communication protocol based on processing a device ID of the gateway device with the firmware. The processor is configured to compare a received passcode prediction of the endpoint device to the passcode computed by the processor. The processor is configured to provide network access to the endpoint device based on the comparison.

Other example aspects of the present disclosure are directed to other systems, methods, apparatuses, tangible non-transitory computer-readable media, and devices for establishing network connection for an endpoint device. These and other features, aspects and operations of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

The detailed description that follows makes reference to the appended figures, in which:

FIG. 1 is a view of a loading dock area in accordance with embodiments of the present disclosure;

FIG. 2 is a schematic of a gateway device and a controllable device in accordance with embodiments of the present disclosure;

FIG. 3 is a schematic of a system for use with controllable devices in accordance with embodiments of the present disclosure;

FIG. 4 is a flow chart of a method of establishing a network connection for an endpoint device in accordance with embodiments of the present disclosure;

FIG. 5 is a flow chart of a method of establishing a network connection for an endpoint device in accordance with embodiments of the present disclosure;

FIG. 6 is a flow chart of a method of changing access credentials for a network in accordance with embodiments of the present disclosure;

FIG. 7 is a flow chart of a method of terminating network access to a non-whitelisted endpoint device in accordance with embodiments of the present disclosure;

FIGS. 8A and 8B illustrate flow charts associated with a method of implementing a security layer in accordance with embodiments of the present disclosure; and

FIGS. 9A to 9C illustrate flow charts associated with a method of implementing a security layer in accordance with embodiments of the present disclosure.

### DETAILED DESCRIPTION

The embodiments set forth below represent the information to enable individuals to practice the embodiments. Upon reading the following description in light of the accompanying figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first message” and “second message,” and does not imply an initial occurrence, a quantity, a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” and phrase “at least one of” as used herein and in the claims is inclusive unless contextually impossible. As an example, the recitation of A or B means A, or B, or both A and B. The word “data” may be used herein in the singular or plural depending on the context.

Example aspects of the present disclosure are directed to systems, apparatuses, and methods of authorizing network access for endpoint devices. Endpoint devices can include or communicate with controllable devices, such as for example, movable barrier operators (such as garage door openers), wireless locks, alarms, cameras, keypads, lockboxes, door locks, lights, etc. Each controllable device can be connected to a remote network through an endpoint device. The endpoint device obtains remote network access from a gateway device, sometimes referred to as an access point. The gateway device is communicatively connected to the remote network through a network interface. The network interface includes one or more communication protocols. The communication protocols can include a local area network (e.g., intranet), wide area network (e.g., the Internet), wireless LAN network (e.g., via WiFi), cellular network, a SATCOM network, VHF network, a HF network, a WiMax based network, or any other suitable communication protocol (or combination thereof) for transmitting and receiving data. In some implementations, the network interface can include a plurality of different types of communication protocols. The gateway device can send and receive signals (e.g., electronic signals) or data (e.g., data from a computing device) to the remote network using at least one of the one or more communication protocols.

Network access to the endpoint device is authorized by the gateway device. The gateway device broadcasts a beacon signal, e.g., every 100 milliseconds (ms), including a service set identifier (SSID) associated with the gateway device. This SSID can include information associated with, but not limited to, a device identifier (ID) associated with the gateway device. In an embodiment, the device ID can include a hexadecimal device ID or another string with any characteristic. The endpoint device receives the beacon signal and determines and/or outputs a passcode prediction associated with an access credential for the gateway device based at least in part on the device ID. In some implementations, the endpoint device determines the passcode prediction by applying a cipher to alphanumeric characters of the device ID. After determining the passcode prediction, the endpoint device transmits the passcode prediction to the gateway device. The gateway device compares the received passcode prediction to a passcode retrieved by the gateway device. The password retrieved by the gateway device is based on the device ID, e.g., using a cipher. The gateway device provides the endpoint device with access to the network based on the result of the comparison. The endpoint device is provided with network access when the passcode prediction matches the passcode retrieved by the gateway device. The endpoint device can be denied network access when the passcode prediction does not match the passcode retrieved by the gateway device.

In some implementations, the endpoint device can perform one or more steps associated with setup or initialization of the controllable device upon receiving access to the network. For example, the controllable device can communicate with a remote server (e.g., a manufacturer's server) to receive and execute setup instructions stored on the remote server. In other implementations, the endpoint device may allow a user to remotely control the controllable device through the network.

Example aspects of the present disclosure can provide numerous technical effects and benefits. For instance, determining a passcode prediction associated with an access credential of a gateway device can reduce the time required to install (e.g., setup and configure) the endpoint device while providing network security. In this manner, security is maintained because the endpoint device must successfully predict the passcode associated with the access credential in order to access the network, while installation time is reduced and simplified, allowing for quicker site setup and reduced project lead time. The systems and methods described herein can further address issues that might occur when the passcode for the gateway device is forgotten by the endpoint device (e.g., at a later time after initialization is completed), when the passcode for the gateway device is not properly recorded or written down, or when the passcode is maintained by a person who is not available or unwilling to provide the passcode for connecting the endpoint device to a network.

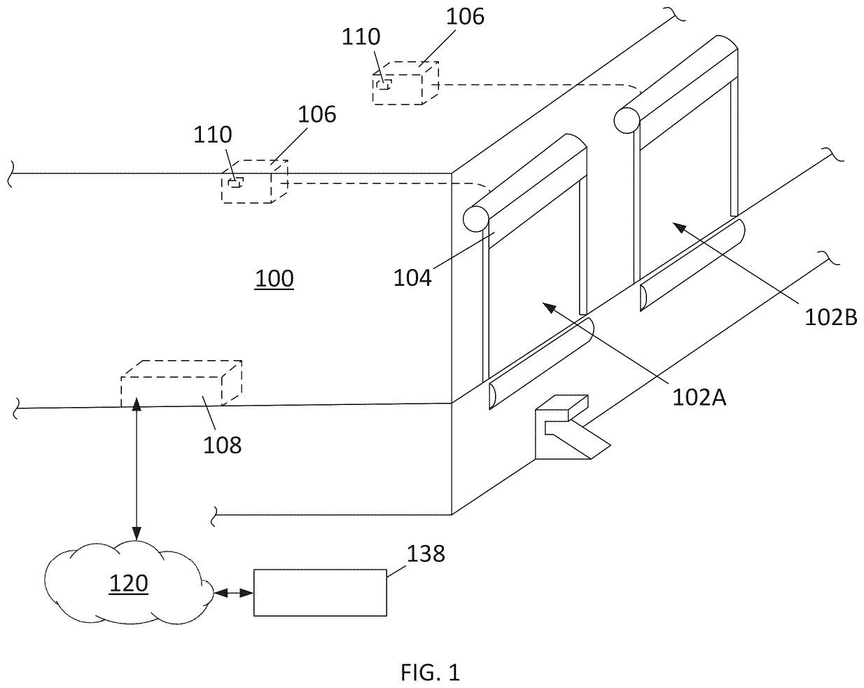

Referring now to the figures, FIG. 1 illustrates a loading dock area 100 in accordance with an example embodiment. The loading dock area 100 includes a plurality of loading docks, such as a first loading dock 102A and a second loading dock 102B. The first and second loading docks 102A and 102B (collectively referred to as loading docks 102) each define a separate controllable entrance to the loading dock area 100. Each of the loading docks 102 includes a movable barrier 104 selectively prohibiting access to the loading dock area 100. The movable barriers 104 are operatively connected to movable barrier operators 106 that move the movable barriers 104 between open and closed positions. By way of example, the movable barriers 104 can include tracked garage door(s), gate arm(s), sliding gate(s), roll up door(s), or the like. The depicted loading dock area 100 is intended as an exemplary environment in which systems, components, and methods described herein can be employed. Other exemplary environments include warehouses and/or logistics facilities/centers, commercial buildings, public and private venues, multi-unit dwellings, infrastructure like garages and roadways, etc. In general, the environment includes one or more secured areas with selective access controlled by the position of the movable barrier(s) 104. The depicted movable barrier operators 106 and movable barriers 104 are intended as exemplary controllable devices disposed in the loading dock area 100. Other exemplary controllable devices include alarms, cameras, keypads, lockboxes, door locks, lights, etc. These controllable devices may be disposed within the loading dock area 100. Each controllable device entails installation and setup to perform controllable functionality.

The loading dock area 100 includes one or more gateway devices 108, often referred to as an access point, that provide network connection to the controllable device(s). In some implementations, the gateway device(s) 108 include a single device. In other implementations, the gateway device(s) 108 may each be comprised of a plurality of physically distinct elements operating together. The physically distinct elements can communicate with one another through wired or wireless interfaces. In some implementations, components of the gateway device(s) 108 can be disposed in the same environment as one another, e.g., within the loading dock area 100. However, the components can also be disposed in different locations relative to the environment. The components may be separated from each other and may not be in visual communication with one another, separated for example, by walls, windows, rafters, temporary barriers, shelving units, equipment, or the like in or around the environment. The number of gateway devices 108 disposed in the environment may depend, for example, on the number of controllable devices in the environment requiring network access, the size of the environment, the physical characteristics of environmental structures (e.g., wall material composition), operator specified requirements, or the like.

The gateway device 108 is configured to communicate wirelessly with one or more endpoint devices 110. In an embodiment, the gateway device 108 can communicate wirelessly with a plurality of endpoint devices 110. Each endpoint device 110 can be associated with one of the controllable devices (e.g., one of the movable barrier operators 106) disposed in the environment 100. For instance, each movable barrier operator 106 can include one endpoint device 110 in wireless communication with the gateway device 108. Wireless communication can be performed using any reliable method including, for example, WiFi, WIMAX, LTR, BLUETOOTH, ZIGBEE, or other proprietary or public wireless communication methods.

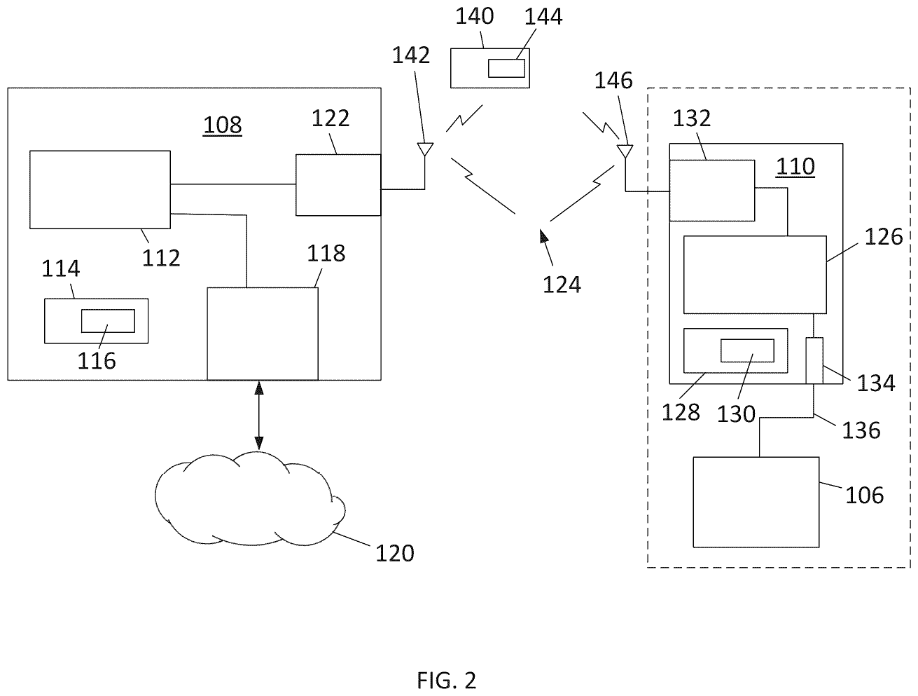

Referring to FIG. 2, the gateway device 108 includes one or more processors 112 and a memory 114. The processor(s) 112 can be any suitable processing device (e.g., a control circuitry, a processor core, a microprocessor, an application specific integrated circuit, a field programmable gate array, a controller, a microcontroller, etc.) and can be one processor or a plurality of processors that are operatively connected. The memory 114 can include one or more non-transitory computer-readable storage media, such as RAM, ROM, EEPROM, EPROM, one or more memory devices, flash memory devices, etc., and combinations thereof. The memory 114 can store information that can be accessed by the processor(s) 112. For instance, the memory 114 (e.g., one or more non-transitory computer-readable storage mediums, memory devices) can include computer-readable instructions 116 that can be executed by the processor(s) 112. The instructions 116 can be software, firmware, or both written in any suitable programming language or can be implemented in firmware or hardware. Additionally, or alternatively, the instructions 116 can be executed in logically and/or virtually separate threads on processor(s) 112. For example, the memory 114 can store instructions 116 that when executed by the processor(s) 112 cause the processor(s) 112 to perform operations such as any of the operations and functions as described herein.

The gateway device 108 can include a communication interface 118. The communication interface 118 can include any circuits, components, software, etc. for communicating via one or more networks (e.g., a remote network 120). In some implementations, the communication interface 118 can include for example, one or more of a communications controller, receiver, transceiver, transmitter, port, conductors, software and/or hardware for communicating data/information. In an embodiment, the communication interface 118 can include a cellular antenna. In other embodiments, the communication interface 118 can include a WiFi transmitter/receiver, a local area network (LAN) communication protocol, or another type of communication interface 118. In some instances, the communication interface 118 can be in communication with a local router, e.g., disposed in the loading dock area 100, that is in communication with the remote network 120.

The gateway device 108 can also include a communication interface 122 used to instantiate a network 124 with one or more of the endpoint devices 110. The communication interface 122 can include any circuits, components, software, etc. for communicating via one or more networks (e.g., network 124). In some implementations, the communication interface 122 can include for example, one or more of a communications controller, receiver, transceiver, transmitter, port, conductors, software and/or hardware for communicating data/information.

The network 124 can be any type of network or combination of networks that allows for communication between devices. In some implementations, the network 124 can include one or more of a local area network, wide area network, secure network, cellular network, mesh network, peer-to-peer communication link and/or some combination thereof and can include any number of wired or wireless links. Communication over the network 124 can be accomplished, for instance, via a network interface using any type of protocol, protection scheme, encoding, format, packaging, etc.

The endpoint device 110 includes one or more processors 126 and a memory 128. The processor(s) 126 can be any suitable processing device (e.g., a processor core, a microprocessor, an ASIC, a FPGA, a controller, a microcontroller, etc.) and can be one processor or a plurality of processors that are operatively connected. The memory 128 can include one or more non-transitory computer-readable storage media, such as RAM, ROM, EEPROM, EPROM, one or more memory devices, flash memory devices, etc., and combinations thereof. The memory 128 can store information that can be accessed by the processor(s) 126. For instance, the memory 128 (e.g., one or more non-transitory computer-readable storage mediums, memory devices) can include computer-readable instructions 130 that can be executed by the processor(s) 126. The instructions 130 can be software, firmware, or both written in any suitable programming language or can be implemented in hardware. Additionally, or alternatively, the instructions 130 can be executed in logically and/or virtually separate threads on processor(s) 126. For example, the memory 128 can store instructions 130 that when executed by the processor(s) 126 cause the processor(s) 126 to perform operations such as any of the operations and functions of any of the computing system(s) as described herein.

Each of the endpoint devices 110 can also include a communication interface 132 used to communicate with one or more other systems. The communication interface 132 can include any circuits, components, software, etc. for communicating via one or more networks (e.g., network 124). In some implementations, the communication interface 132 can include for example, one or more of a communications controller, receiver, transceiver, transmitter, port, conductors, software and/or hardware for communicating data/information. The endpoint device(s) 110 can communicate with the gateway device 108 through the network 124 using the communication interface 132.

Each of the endpoint devices 110 can also include a communication interface 134 used to communicate with one or more other systems, such as the movable barrier operator 106. The communication interface 134 can include any circuits, components, software, etc. for communicating with the movable barrier operator 106. In some implementations, the communication interface 134 can include for example, a port configured to communicate with the movable barrier operator 106 through a wired connection 136. In other implementations, the endpoint device 110 can be directly associated (e.g., integral or unitary) with the movable barrier operator 106, such as part of a control circuitry or processor(s) of the movable barrier operator 106. The endpoint device 110 can be mounted to, on, or in the movable barrier operator 106. In yet another implementation, the communication interface 134 can communicate with the movable barrier operator 106 through a wireless connection.

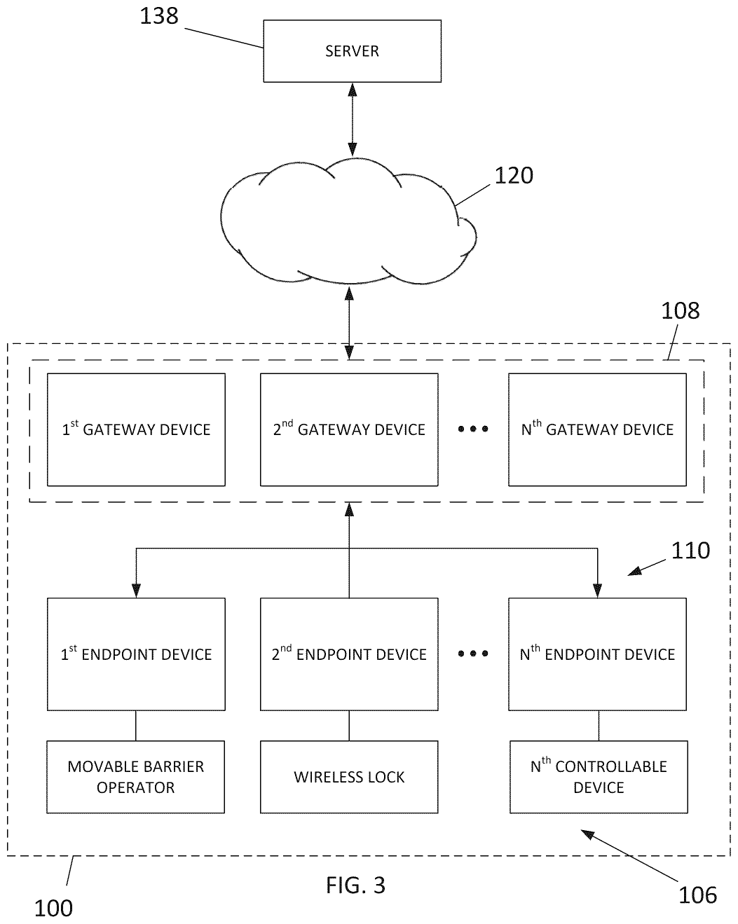

Referring to FIGS. 1 and 3, the environment 100 can include a plurality of endpoint devices 110 (e.g., a 1^{st} endpoint device 110 to an n^{th} endpoint device 110) each associated with one or more controllable device(s). In an embodiment, each endpoint device 110 is associated with one controllable device, such as one of the movable barrier operators 106. In some implementations, the endpoint devices 110 may be associated with different types of controllable devices. For example, a first endpoint device 110 may be associated with a movable barrier operator 106 and a second endpoint device 110 may be associated with a wireless lock. In further examples, the endpoint devices 110 may be associated with security features such as an alarm, a camera, a keypad, a lockbox, a door lock, a light, etc. The endpoint device 110 provides a communicative connection between the controllable device (e.g., the movable barrier operator 106) and the gateway device 108 as described below.

In some implementations, the environment 100 includes three (3) or more endpoint devices 110, such as ten (10) or more endpoint devices 110, such as twenty-five (25) or more endpoint devices 110, such as fifty (50) or more endpoint devices 110, such as one hundred (100) or more endpoint devices 110, etc. Each controllable device associated with an endpoint device 110 typically entails initial installation, setup, and configuration. This may occur, for example, during an initial buildout or a retrofitting operation. Often, the endpoint device 110 is connected to a network (e.g., network 120) for access to the Internet and a remote server 138 (e.g., a manufacturer's server) or middleware. The server 138 can include one or more computers that provide functionality for an application on the controllable device. The server 138 may also provide functionality for the endpoint device 110. Although server 138 is shown in FIG. 3 as a single server computer, it is understood that various configurations for server computers may be employed (e.g. computers can be separated/distributed or consolidated/combined).

Traditionally, the installation process (including setup and configuration) of a controllable device, such as a movable barrier operator, was performed manually. Access to wireless networks was established by manual or forcible entering of access credentials into the controllable device to connect the controllable device to a local router or network implement for network access. For environments with large numbers of controllable devices, this meant individually setting up and configuring each of the controllable devices, incurring significant time and resources. Additionally, access to local site routers and network communication implements is not guaranteed at many commercial worksites. In this manner, controllable devices seeking network access for quicker setup and configuration entail additional operator time for manual configuration.

Gateway devices 108 can be deployed to facilitate network connection for controllable devices associated with endpoint devices 110 in large environments 100 or environments 100 with many endpoint devices 110. For large environments 100, one or more gateway devices 108 (e.g., a 1^{st} gateway device 108 to an n^{th} gateway device 108) can be located within the environment 100. The gateway device(s) 108 can be positioned at locations to provide network access to all endpoint devices 110 in the environment 100.

Each gateway device 108 can support a plurality of endpoint devices 110. For example, one gateway device 108 can support at least ten (10) endpoint devices 110, such as at least twenty (20) endpoint devices 110, such as at least fifty (50) endpoint devices 110, such as at least one hundred (100) endpoint devices 110, etc. Thus, each gateway device 108 can support a plurality of controllable devices.

At least one of the gateway devices 108 may be installed in the environment 100 prior to setting up at least one of the endpoint devices 110 (and controllable devices). Installation of the gateway device 108 can include electrically coupling the gateway device 108 to a power source and initializing network access (e.g., to network 120). The gateway device 108 can transmit a beacon signal 140 (FIG. 2) within the environment, for example using an antenna 142 associated with the communication interface 122. The beacon signal 140 includes a unique identifier or device ID 144 associated with the gateway device 108. For example, the device SSID broadcast by the gateway device 108 can include a device identifier (ID) of the gateway device 108. The device ID contains an alphanumeric string of characters that uniquely identify the gateway device 108, such as a predefined prefix and a serial number.

The endpoint device 110 and controllable device are installed in the environment 100 by one or more technicians. For example, where the endpoint device 110 is associated with the movable barrier operator 106, installation can include installing the movable barrier operator 106 at a location in the environment 100 to allow for interaction with the movable barrier 104. Installation further includes providing power to the movable barrier operator 106 (e.g., from a wall outlet or mains power source). Power can be provided to the endpoint device 110 through the movable barrier operator 106, such as when the endpoint device 110 is part of the movable barrier operator 106 (e.g., part of the processor or control circuit of the movable barrier operator 106), or provided to the endpoint device 110 separately by a separate electrical connection between the endpoint device 110 and a power source. In some instances, the endpoint device 110 automatically initiates a startup procedure in response to receiving power. In other instances, initializing the startup procedure of the endpoint device 110 entails switching the endpoint device 110 (e.g., via a user interface of the endpoint device 110) to an ON state. In some implementations, the startup procedure can include seeking network access from the gateway device 108 as described below.

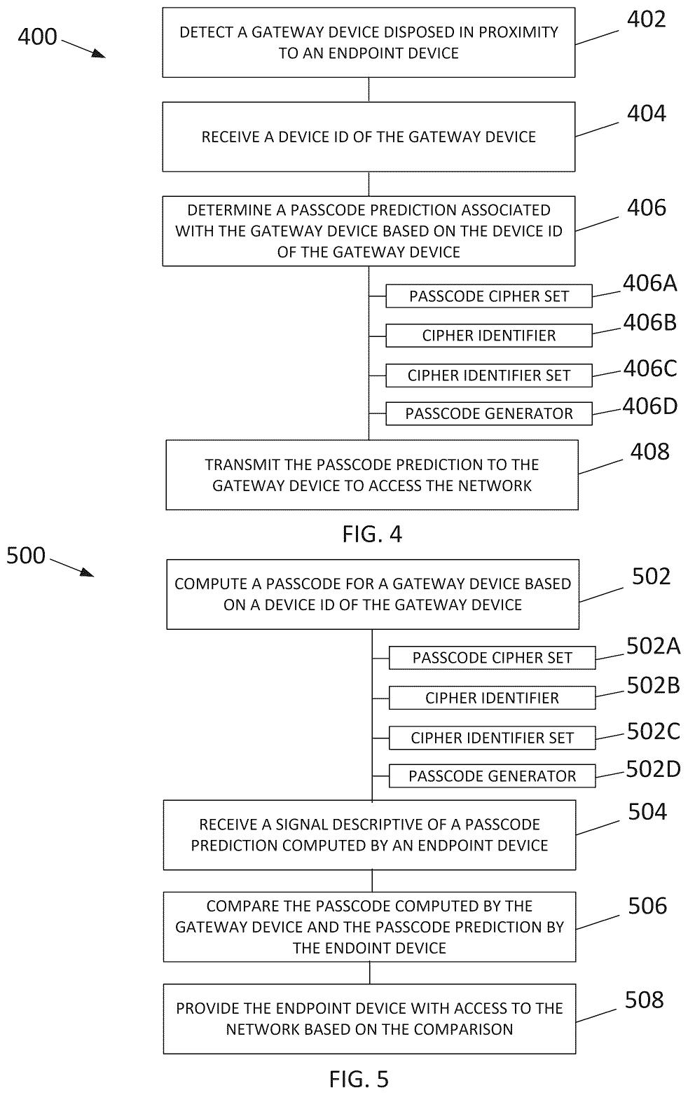

Referring now to FIG. 4, a flow diagram of a method 400 of establishing a network connection for an endpoint device is provided according to example embodiments of the present disclosure. In general, the method 400 will be described with reference to a system including the gateway device 108 and the endpoint device 110 described above with reference to FIGS. 1 to 3. In addition, although FIG. 4 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 400 can include detecting 402, by an endpoint device including one or more processors, a gateway device in proximity to the endpoint device. Detecting 402 the gateway device can occur as a result of the endpoint device listening for beacon signals generated by a gateway device. Detection 402 of the beacon signal(s) may occur during an initial startup procedure, such as after providing power to the endpoint device, or after the initial startup procedure, such as when a previous connection with a previous gateway device is lost or terminated.

In some implementations, detecting 402 the gateway device results in the detection of a plurality of different gateway devices. Each gateway device may broadcast a beacon signal detected 402 by the endpoint device. For example, the endpoint device may receive a first beacon signal from a first gateway device and a second beacon signal from a second gateway device. The strength of each of the received beacon signals can be measured by the endpoint device in view of a received signal strength indication (RSSI) or another known signal strength protocol. The first beacon signal and the second beacon signal are then compared to one another by the endpoint device. The endpoint device can select the gateway device in response to the comparison. Typically, the comparison is performed in view of RSSI and the endpoint device selects a particular gateway device with a network/signal that is stronger as indicated by a better RSSI relative to another gateway device. Alternatively the end point selects a gateway device with a network/signal that has another parameter of interest (e.g., bandwidth, data throughput/speed, quality of service ‘QoS’, noise floor, interference immunity, etc.) that is enhanced or improved relative to another network/signal option. Other considerations can include relative loading of the gateway devices (e.g., how many endpoint devices are already connected or actively connecting with the gateway device(s)), special commands or instructions received by the endpoint device or contained within the memory of the endpoint device, etc.

The method 400 further includes receiving 404, at the endpoint device, a unique identifier (device ID) of the gateway device, such as a service set identifier (SSID) associated with the gateway device. The SSID is a unique alphanumeric string of characters associated with the gateway device that is not duplicated between gateway devices. The device ID can alternatively include another unique identifier associated with the gateway device. In some implementations, the device ID is included in the detected beacon signal. In other implementations, the device ID may not be broadcast in the beacon signal. Instead, the endpoint device transmits a probe request to the gateway device in response to detecting 402 the gateway device. The gateway device can respond to the probe request with a probe response message containing the device ID.

The method 400 further includes determining 406, by the endpoint device, a passcode prediction associated with the gateway device based at least in part on the device ID of the gateway device, or a subset of the device ID where the subset includes less than the entire device ID. Determining 406 the passcode prediction can be performed by one or more processors of the endpoint device in view of instructions saved on local memory. The instructions can include, for example, a passcode cipher set 406A including a plurality of different passcode ciphers each configured to determine 406 the passcode prediction under a particular circumstance. Each passcode cipher includes one or more keys (e.g., algorithms) that, when used in the correct circumstance, decrypts an encrypted password, such as a symmetric-key encryption or asymmetric-key (public-key) encryption, of the device ID to generate the predicted passcode of the gateway device.

Determining 406 the correct passcode cipher from the passcode cipher set 406A can be performed in view of one or more characteristics of the device ID. For example, the instructions can include a cipher identifier 406B configured to determine the correct passcode cipher from the passcode cipher set 406A. The cipher identifier 406B can be implemented by the processor of the endpoint device to determine the proper passcode cipher for a gateway device based on one or more characteristics of the device ID. For instance, the cipher identifier 406B can cause the processor to evaluate a particular character value of the device ID (e.g., a value of the first character of the device ID, a value of the second character of the device ID, etc.), a checksum value associated with the device ID, a hash function of the device ID, or the like. The evaluated aspect of the device ID can be compared to a cipher identifier set 406C including a plurality of cipher identifier values. Each cipher identifier value in the cipher identifier set 406C corresponds to a particular passcode cipher from the passcode cipher set 406A. The correct passcode cipher is selected from the passcode cipher set 406A in view of the comparison between the cipher set identifier set 406C and the evaluated aspect of the device ID. The processor can execute a passcode generator 406D to apply the selected passcode cipher to the device ID in order to determine the passcode prediction.

The following example is provided for better understanding generation or determination of the passcode prediction by the endpoint device using the received device ID of the gateway device. The example is not intended to be limiting.

An exemplary gateway device includes an SSID of “749M7X23”. An endpoint device has a cipher identifier including a cipher identifier set with three cipher identifier values. A first cipher identifier value describes that if the evaluated aspect of the device ID is equal to 3, then apply an encryption protocol where each character of the device ID is moved one digit to the right with the terminal digit moving to the beginning and increases the value of each character by one value. A second cipher identifier value describes that if the evaluated aspect is equal to Y, then apply an encryption protocol where the device ID is reversed (formed backwards). A third cipher identifier value describes that if the evaluated aspect is equal to 0, then apply an encryption protocol where letters are moved in the order listed in the device ID to the front and numbers are moved in the order listed in the device ID to the back. The first, second, and third cipher identifier values differ from one another and each provide a different protocol for decrypting the device ID to generate, compute, calculate or otherwise output the passcode prediction. The use of three cipher identifier values in the example is done for ease of explanation. It should be understood that the cipher identifier set can include at least 5 (five) cipher identifier values, such as at least 10 (ten) cipher identifier values, such as at least 20 (twenty) cipher identifier values, such as at least 50 (fifty) cipher identifier values, etc.

The cipher identifier in the above example is programmed to evaluate a specific character of the alphanumeric string of characters associated with the device ID. Information relating to the specific character may be stored in local memory at the endpoint device. By way of example, the cipher identifier in the above example is configured to evaluate the terminal (last) character of the alphanumeric string. Since the last value of the SSID in the example is equal to “3”, the processor identifies the first cipher identifier value as TRUE, the second cipher identifier value as FALSE, and the third cipher identifier value as FALSE. The processor then selects the first encryption protocol in view of the first cipher identifier value being indicated as TRUE. The processor then applies the encryption protocol of the first cipher identifier value to the device ID to determine the passcode prediction. For an encryption protocol that causes transposition of each character one digit to the right with the terminal digit moving to the beginning and increases the value of each character by one value, as with the first cipher identifier value, the SSID of “749M7X23” becomes “4850N8Y3”. Thus, the predicted passcode would be “4850N8Y3”. It should be understood that the foregoing is but one example and that other encryption protocols may be utilized within the scope of the disclosure.

In some implementations, the characters of the device ID (or a portion thereof) are decrypted using multiple encryption protocols. For instance, two or more of the cipher identifier values can be TRUE for a single device ID. In these instances, the cipher identifier can cause the processor to decrypt the predicted passcode from the device ID using the encryption protocols of the two or more cipher identifier values. The cipher identifier may perform the encryption protocol serially based on the location of the cipher identifier value in the cipher identifier set, (e.g., first-listed-first-used, last-listed-last-used, etc.). Alternatively, the cipher identifier can select from the different TRUE cipher identifier values based on an attribute of the device ID, information saved in the local memory, from instructions received from the gateway device, or the like.

The method 400 further includes transmitting 408 the predicted passcode to the gateway device to request or attempt to access the network. Transmission 408 of the predicted passcode is performed over a network, such as the network 124 depicted in FIG. 2.

FIG. 5 is a flow diagram of a method 500 of establishing a network connection for an endpoint device according to example embodiments of the present disclosure. In general, the method 500 will be described with reference to a system including the gateway device 108 and the endpoint device 110 described above with reference to FIGS. 1 to 3. In addition, although FIG. 5 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure.

The method 500 can include determining (e.g., computing 502), by a gateway device communicatively connected to a network, a passcode for the gateway device based on a device ID of the gateway device. Determination 406 of the passcode prediction by the endpoint device as shown in FIG. 4 is intended to generate or otherwise produce and output the same passcode as the passcode retrieved and/or computed 502 by the gateway device. In this regard, the gateway device (i.e., processor(s) of the gateway device) is configured to determine a cipher and apply decryption to the device ID in view of the cipher to obtain the passcode for the gateway device and permit network access to the endpoint device. In some implementations, computing 502 the passcode is performed prior to the endpoint device detecting 402 the gateway device. For example, computation 502 of the passcode can occur during initial setup of the gateway device. The gateway device can store the computed passcode in local memory for later retrieval and use. In other implementations, computing 502 the passcode is performed at a generally same time as the endpoint device detecting 402 the gateway device or after the endpoint device detects 402 the gateway device.

In some implementations, computing 502 the passcode at the gateway device can be performed in a manner similar to determining 406 the passcode prediction at the endpoint device. For example, the passcode is based at least in part on the device ID of the gateway device. Computing 502 the passcode can be performed by one or more processors of the gateway device in view of instructions saved on local memory. The instructions can include a passcode cipher set 502A including a plurality of different passcode ciphers each configured to compute 502 the passcode prediction under a particular circumstance. Each passcode cipher includes one or more keys (algorithms) that, when used in the correct circumstance, decrypt a symmetric-key encryption or asymmetric-key (public-key) encryption of the device ID to generate the passcode of the gateway device.

Determining the passcode cipher from the passcode cipher set 502A can be performed in view of one or more characteristics of the device ID. For example, the instructions can include a cipher identifier 502B configured to determine the correct passcode cipher from the passcode cipher set 502A. The cipher identifier 502B can be implemented by the processor of the gateway device to determine the proper passcode cipher based on one or more characteristics of the device ID. For instance, the cipher identifier 502B can cause the processor to evaluate a particular character value of the device ID (e.g., a value of the first character of the device ID, a value of the second character of the device ID, etc.), a checksum value associated with the device ID, a hash function of the device ID, or the like. The evaluated aspect of the device ID can be compared to a cipher identifier set 502C including a plurality of cipher identifier values. Each cipher identifier value in the cipher identifier set 502C corresponds to a particular passcode cipher from the passcode cipher set 502A. The passcode cipher is determined in view of the comparison between the cipher set identifier set 502C and the evaluated aspect of the device ID. The processor can execute a passcode generator 502D to apply the selected passcode cipher to the device ID in order to generate, compute, calculate or otherwise determine the passcode. In some instances, the gateway device can store the computed 502 passcode in local memory for later access.

In one implementation, the passcode can be computed 502 at a remote server and communicated to the gateway device through the network. The remote server can perform one or more computations to determine the passcode in view of the device ID of the gateway device using, for example, the method described above. The computed 502 passcode can be transmitted to the gateway device and optionally stored locally at the gateway device for current or later use.

The method 500 further includes receiving 504, at the gateway device, a signal descriptive of a passcode prediction computed by an endpoint device. Receipt 504 of the signal can occur in response to the endpoint device transmitting 408 the passcode prediction to the gateway device as shown in FIG. 4. The received 504 signal can include one or more signals transmitted from the endpoint device. The signal(s) may be acquired with an analog-to-digital converter to allow for computer processing. The acquired signals can include a number of data points. The signals can be processed, parsed, and/or organized to extract the passcode prediction.

The method 500 can further include comparing 506 the passcode computed 502 by the gateway device and the received 504 passcode prediction from the endpoint device. In some implementations, comparing 506 the passcode and passcode prediction is performed by retrieving the computed passcode from the local memory of the gateway device. The processor(s) of the gateway device can perform the passcode comparison locally to determine if the passcode prediction matches the computed passcode. In other implementations, comparing 506 the passcode to the passcode prediction can be performed remotely, e.g., at a remote server. For example, an authentication server can compare the passcode to the passcode prediction and grant network access for the endpoint device based on the comparison at the authentication server. Next, the gateway device may receive confirmation (e.g., from the authentication server) that network access can be granted for the endpoint device, whereby the gateway device can grant network access for the endpoint device.

The method 500 can further include providing 508 the endpoint device with access based on the comparison 506. The endpoint device is granted network access when the passcode prediction matches the passcode computed by the gateway device. In response to granting network access, the gateway device may transmit an access grant message to the endpoint device. The access grant message can include one or more rules indicating access rights for the endpoint device. The endpoint device can be denied network access when the passcode prediction does not match the passcode computed by the gateway device. In some implementations, the gateway device can transmit an access denial message to the endpoint device in response to denying network access. In response to receiving the access denial message, the endpoint device may again attempt to determine 406 the passcode prediction and transmit 408 the newly determined passcode prediction to the gateway device. In some instances, further attempts to determine 406 and transmit 408 the passcode prediction can be prevented, e.g., by the gateway device. In some implementations, the endpoint device may be allowed to attempt a preset number of passcode predictions before the endpoint device is denied further attempts. For example, the endpoint device may be allowed two (2) attempts, three (3) attempts, four (4) attempts, five (5) attempts, etc.

Once network access is granted to the endpoint device, the endpoint device may communicate with the remote server, e.g., the manufacturer's server, through the gateway device. Network access can allow the endpoint device to perform one or more steps associated with endpoint device setup and configuration. For example, the endpoint device may receive instructions and communicate with the remote server to self-configure, including for example, validating information of the endpoint device (e.g., a MAC address or a physical location) with the remote network, updating firmware or software, or the like.

In an embodiment, the gateway device can manage network access for a plurality of endpoint devices. In some implementations, each endpoint device can request and receive network access from the gateway device in a similar manner as described above. For example, the gateway device can receive a second signal descriptive of a passcode prediction determined by a second endpoint device, compare the passcode computed by the gateway device and the passcode prediction determined by the second endpoint device, and provide the second endpoint device with access to the network based on the comparison. This process can be repeated for more or all endpoint devices in the environment. In some implementations, the gateway device can simultaneously grant network access to a plurality of endpoint devices. In other implementations, the gateway device can serially grant network access, e.g., sequentially based on request order.

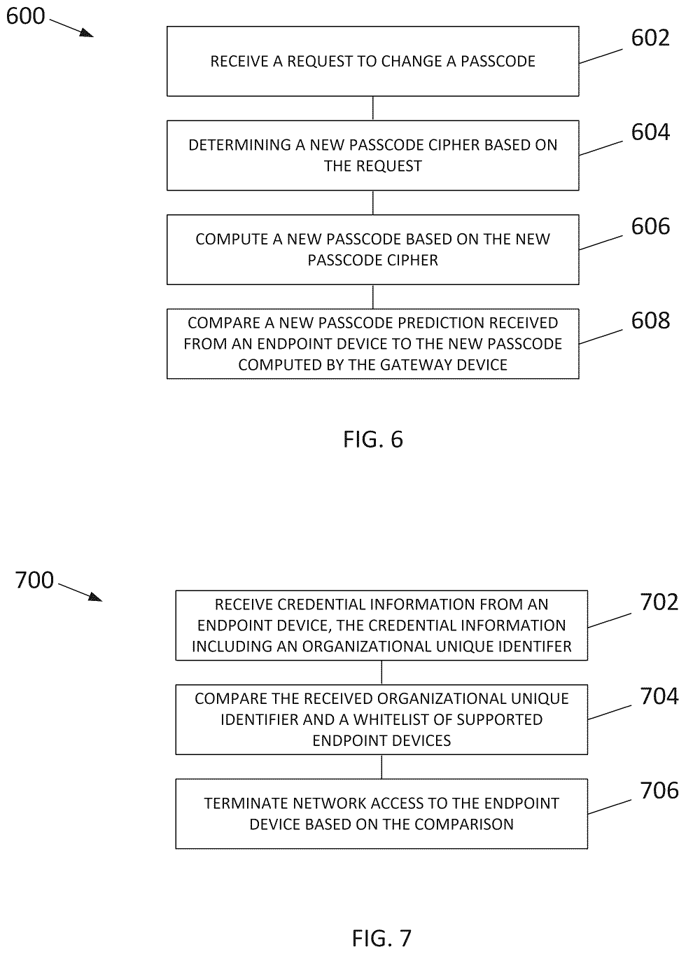

In certain instances, it may be necessary to change the passcode associated with network access, e.g., as a result of a security breach. This may occur after one or more endpoint devices have already been granted access to the network. FIG. 6 is a flowchart of a method 600 of changing access credentials for the network according to example embodiments of the present disclosure. The method can include receiving 602 a request to change the passcode. The request can be received at the gateway device. In some implementations, the request can be generated by a remote device (such as a smart device) of a user in communication with the gateway device. In other implementations, the request can be generated by the remote server, e.g., in response to a password change request communicated to the server from a remote device (such as a smart device) of a user. The server can communicate the request to the gateway device wirelessly over the network. The request can include passcode change information used by the gateway device to change the passcode. In an embodiment, the passcode change information includes an updated passcode cipher identifier. The updated passcode cipher identifier can replace the current passcode cipher identifier used to compute 502 the passcode at the gateway device and used to determine 406 the passcode prediction at the endpoint device. The endpoint device may receive the updated passcode cipher identifier from the gateway device or from another device.

The method 600 can further include determining 604, at the gateway device, a new passcode cipher based on the request. For example, the gateway device can select the new passcode cipher from the passcode cipher set based on the updated passcode cipher identifier received 602 in the request. Using methodology like that described above, the gateway device can determine 606 a new passcode based on the new passcode cipher. Similarly, using the methodology described above, the endpoint device can determine a new passcode prediction based on the new passcode cipher. In another embodiment, determining 604 the new passcode cipher can be based on a lookup table and/or indexing process. For example, when the gateway device is instructed to update its passcode, the gateway device may reference the lookup table and increment or decrement in the data structure from a current passcode to determine the new passcode. The lookup table can be stored and access locally at the gateway device or accessed from a remote server. Similarly, the endpoint device can include the lookup table and similarly increment or decrement in the data structure to determine the new passcode prediction.

After determining 606 the new passcode, the endpoint device can then transmit the new passcode prediction to the gateway device. The gateway device can then compare 608 the new passcode prediction received from the endpoint device to the new passcode computed by the gateway device and grant network access based on the comparison.

In some instances, the gateway device can whitelist supported endpoint devices. The gateway device can terminate network access for non-whitelisted endpoint devices. For example, FIG. 7 illustrates a flow chart of a method 700 of terminating network access to a non-whitelisted endpoint device according to an example embodiment. The method 700 includes receiving 702 credential information from an endpoint device, the credential information including a unique identifier associated with the endpoint device, such as an organizational unique identifier (OUI) or a MAC address. The credential information can be received 702 at the gateway device, e.g., as part of an initial message(s) received from the endpoint device during setup or initialization of the endpoint device during or after activation of network access to the endpoint device.

In the depicted implementation, the method 700 further comprises comparing 704 the received OUI and a whitelist including information associated with authorizable endpoint devices. The whitelist of supported endpoint devices can include a list of supported endpoint devices, identified, e.g., by their unique identifier (e.g., OUI or MAC address). In some implementations, comparison 704 can be performed locally at the gateway device, e.g., by the processor(s) of the gateway device. In other implementations, comparison 704 can be performed at least partially at the remote server. Endpoint devices verified as whitelisted can connect or remain connected to the network. However, the method 700 can further include terminating 706 network access to endpoint devices based on the comparison, e.g., when the unique identifier of the endpoint device is not present on the whitelist.

In some implementations, the gateway device can assign network access rules in response to or during authorization of network access. For example, endpoint devices can have limited network access to, e.g., preapproved servers (e.g., a manufacturer's server). The gateway device can restrict network access to certain endpoint devices. Unique identifying information associated with the endpoint device (e.g., OUI or MAC address information) can be compared by the gateway device to determine network access rules for each endpoint device.

In certain instances, network access may be improperly terminated, such as for example, upon accidental loss of connection between the endpoint device and the gateway device in the event of power failure. In some implementations where the environment includes a plurality of gateway devices, the endpoint device can automatically reconnect to the network, e.g., in response to connection loss, by interfacing with a different gateway device in the environment. Interfacing with the different gateway device can be performed using the method 400 depicted in FIG. 4. In an embodiment, the endpoint device is configured to automatically initiate interfacing with a different gateway device after network access is terminated for a preset duration of time, such as 10 seconds, 30 seconds, 60 seconds, etc. During the duration of time, the endpoint device may attempt to reconnect to the previously-interfaced gateway device, e.g., by listening for a beacon signal associated with the previously-interfaced gateway device or by transmitting a probe request to the previously-interfaced gateway device. Since the endpoint device is already granted network access, in some implementations the endpoint device may reconnect to the previously-interfaced gateway device without requiring determination of a new passcode prediction.

In some implementations, periodic review of network access can occur, e.g., at the endpoint device. For example, after the endpoint device connects to a different gateway device, the endpoint device may periodically (e.g., after set durations of time) attempt to reconnect to the previously-interfaced gateway device. In an embodiment, the endpoint device can periodically perform RSSI tests and attempt to connect to a new gateway device in response to a higher RSSI of the new gateway device. In this instance, the endpoint device can interface with the new gateway device using the method 400 depicted in FIG. 4. In an embodiment, the endpoint device can retain (store in memory) predicted passcodes associated with each gateway device. In some instances, only successful passcode predictions (passcode predictions verified as correct, e.g., through granting of network access) may be retained. The endpoint device may recall the predicted passcode when reconnecting to a previously-interfaced gateway device. Where the recalled passcode prediction fails (for example, as a result of a user request to reset the passcode), the endpoint device can use the method 400 depicted in FIG. 4 to predict the passcode and connect to the gateway device. In some implementations, the endpoint device may connect to the new gateway device in response to the new gateway device being installed in the environment. That is, as new gateway devices are introduced within the environment, nearby endpoint devices may automatically connect to these new gateway devices, e.g., in response to determining that the signal strength of the new gateway device is greater than the signal strength of the previously-interfaced gateway device.

In some implementations, it may be desirable to implement a security layer to validate one or more devices associated with the embodiments described above. The security layer can validate device authority, for example, using a two-way validation protocol. The two-way validation protocol can be performed between the endpoint device and the gateway device, for example, using local mTLS authentication. Alternatively, the two-way validation protocol can include an EAP authentication method, such as for example, EAP-TLS, PEAP, EAP-TTLS, EAP-SIM, EAP-AKA, or TEAP. In some implementations, two-way validation can be carried out over a separate RADIUS server or a co-located RADIUS server running, e.g., on the gateway device hardware. Importantly, two-way validation allows for cross-validation to ensure a secure connection between the endpoint device(s) and the gateway device(s) and claiming capability, e.g., through a network server.

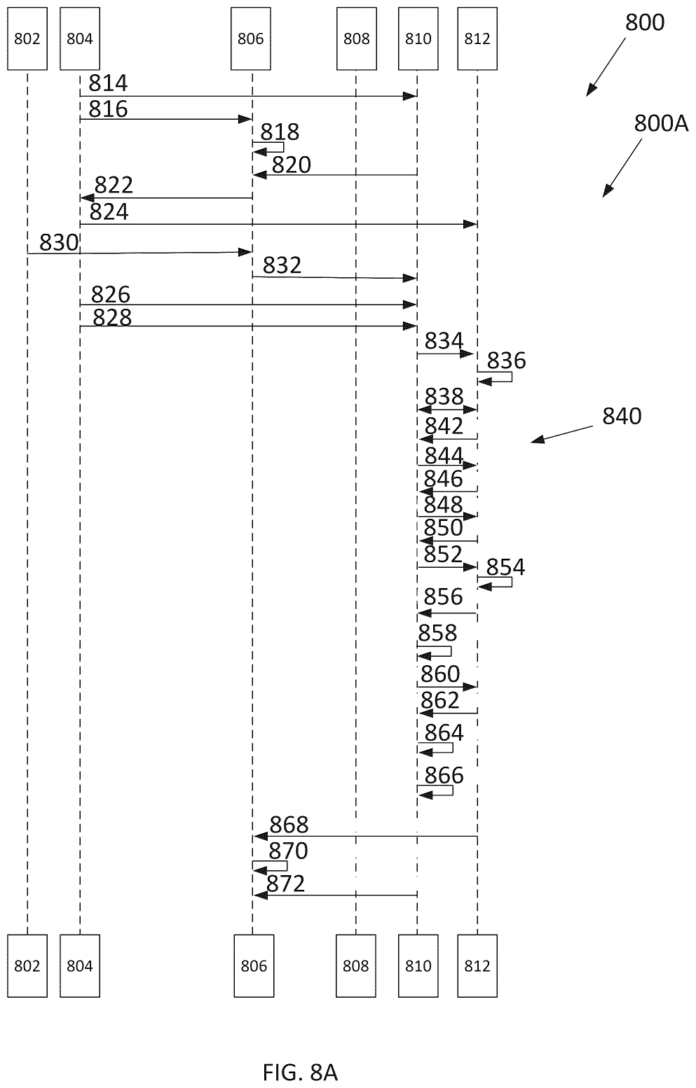

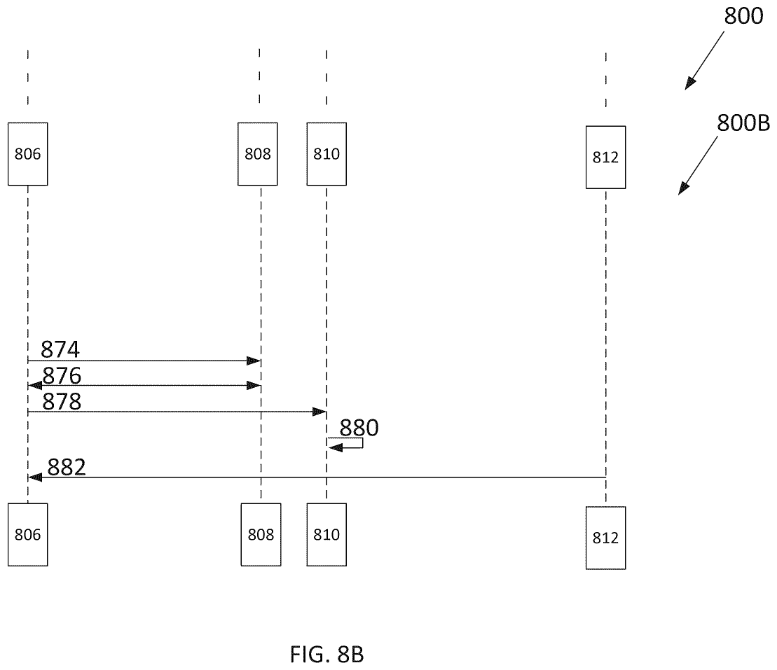

FIGS. 8A and 8B illustrate a flow chart of an example method 800 of implementing the security layer for device validation. In particular, FIG. 8A illustrates a first portion 800A of the method 800 and FIG. 8B illustrates a second portion 800B of the method 800. The method 800 includes steps performed by various entities, including hardware, software, firmware, humans, and the like. The various entities can include, but are not limited to, a manufacturer 802, an installer 804 (such as an original installation technician, a subsidiary installation technician, or a service technician), a remote server 806 such as a cloud, a facility person 808 associated with a site at which the method is being performed (such as a facility owner and/or operator, personnel associated with the facility, or the like), a gateway device 810, and an endpoint device 812. Although FIGS. 8A and 8B depict steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure. Moreover, while steps are depicted in FIGS. 8A and 8B as abstractions, each step may include (encapsulate) one or a series of several messages exchanged between the participating entities. In some instances, one or more of the messages may be routed directly between the participating entities. In other instances, the messages may be routed through an intermediary, such as when communicating between the RADIUS server and the endpoint device.

The method 800 can initiate at step 814 when the installer 804 powers on the gateway device 810. This may happen, for example, during an initial installation phase at a job site. The installer 804 may mount the gateway device 810 at a suitable location within the area of the job site. In some instances, the gateway device 810 is mounted to the ceiling or near the ceiling, out of reach of pedestrians and facility workers below. The method 800 can further include the installer adding 816 the gateway device 810 to the remoter server 806. For example, the remote server 806 may include a manufacturer's network (or external host) running an application that allows an installer 804 or facility person 808 to link (sometimes referred to as “claim”) a physical device on an application or database running on the manufacturer's network (or the external host). This allows the facility person 808, one or more employees or site workers, or any other credentialed person to manage facility equipment at a single location, such as through a local application on a user device that communicates with the manufacturer's network. At step 818 the gateway device 810 is added to the remote server 806. For example, the remote server 806 can add the gateway device 810 to a registry or database. In some implementations, the remote server 806 can mark the gateway device 810 as unclaimed when the gateway device is added to the remote server 806 at step 818. Once added 818 to the remote server 806, the gateway device 810 can present an online status and/or periodically transmit 820 with the remote server 806. The remote server 806 can then notify 822 the installer 804 that the gateway device 810 is online and functional. Notification may occur through the manufacturer's network or another network (e.g., the network can transmit a notification to a user device associated with the installer 804), through indication at the gateway device 810 (e.g., illumination of lights, generation of a confirmation sound, information displayed on a screen, etc.), or the like.

The installer 804 can power on 824 the endpoint device 812. By way of non-limiting example, the endpoint device 812 can be a movable barrier operator, a gate access device, loading dock equipment (such as dock levelers, door lights, dock sensors and/or cameras, etc.), a dock management system, and/or other facility equipment. The installer 804 can mount the endpoint device 812 within or at the facility, provide the endpoint device 812 with power from a local power source, such as a nearby wall outlet, and interact with one or more buttons, switches, etc. to power on 824 the endpoint device 812. In some implementations, the gateway device 810 is powered on 814 before powering on 824 the endpoint device 812. In other implementations, powering on 824 the endpoint device 812 can occur prior to, or at substantially the same time as, powering on the gateway device 810.

With the gateway device 810 and endpoint device 812 powered on 814, 824, the installer 804 causes the gateway device 810 to enter 826 a learn mode. The installer 804 further causes the endpoint device 812 to enter 828 a learn mode. In some implementations, the gateway device 810 and endpoint device 812 can each enter learn mode through manipulation of a physical user interface located at the gateway and endpoint devices 810, 812 respectively. The physical interface can include, for example, a button, a dial, a knob, a touch screen, a keypad, or the like. In other implementations, the gateway device 810 can enter 826 learn mode through remote control either locally (e.g., via radio signal, near field communication (NFC), or the like) or via a remote server interfacing with a local client running on a user device. Remote control may be beneficial where the gateway device 810 is mounted at a difficult-to-reach location. In this regard, the installer 804 can power on 814 the gateway device 810 without requiring a ladder or lifting equipment. In yet other implementations, one or both of the gateway device 810 and/or endpoint device 812 can enter the learn mode 826, 828 as a result of being powered on 814, 824.

Requiring the gateway device 810 and the endpoint device 812 to enter 826, 828 learn mode provides assurance of physical possession of the devices at the facility, thereby providing security against third party attackers intercepting the learn mode handshake and taking over control of the endpoint device 812. As described below, the individual learn modes entered into by the gateway device 810 and the endpoint device 812 can each be defined by a discrete period of time, such as 30 seconds, 60 seconds, two minutes, five minutes, ten minutes, or the like. In some instances, the installer 802, facility person 808, or another authorized person can adjust the learn mode duration. For example, the device can include a user interface including an option to modify the learn mode duration. Upon expiration of the learn mode duration, the device exists learn mode, thereby requiring performance of steps 826, 828 to reinitiate learn mode. In some implementations, the gateway device 810 and the endpoint device 812 can have a common learn mode duration. In other implementations, learn mode duration can be different for the gateway device 810 and the endpoint device 812. For example, the learn mode duration for the gateway device 810 can be longer than the learn mode duration for the endpoint device 812. Alternatively, the learn mode duration for the gateway device 810 can be longer than the learn mode duration for the endpoint device 812. In some implementations, the gateway device 810 and/or the endpoint device 812 can notify the installer 804 or another entity when the learn mode duration is near expiration and/or expired. For instance, the gateway device 810 and/or the endpoint device 812 can generate a visual indication, an audible indication, a tactile indication, or the like. In a non-limiting example, the gateway device 810 can change the color of a visual indicator when the remaining learn mode duration is less than a prescribed time period, such as less than 10 seconds. The gateway device 810 can further change the color of the visual indicator when the learn mode duration expires.

In some instances, one or both of the gateway device 810 and/or the endpoint device 812 can be locked down by the manufacturer 802 prior to shipping. Lockdown of the gateway or endpoint device(s) 810, 812 prevents unauthorized use prior to arrival of the device(s) at the facility. Locking down the gateway device 810 and/or the endpoint device 812 may, for example, inhibit access to the learn modes. When the gateway device 810 is locked down by the manufacturer 802, the method 800 further includes disabling 830 the lockdown. Disabling 830 the lock down can be performed by the manufacturer 802, automatically or manually, for example, using the remote server 806. The remote server 806 can receive a lock down disable signal from the manufacturer 802 and transmit 832 the lock down disable signal or another control signal to the gateway device 812. Where the endpoint device 812 is locked down, the process can be repeated as necessary with the endpoint device 812. In some instances, disabling 830 the lock down can occur in response to a lockdown disablement request, such as generated by the installer 804 or the facility person 808. In an embodiment, the gateway device 810 and the endpoint device 812 can be simultaneously released from lockdown.

After entering the learn mode 826, 828 at both the gateway device 810 and the endpoint device 812, the gateway device 810 can transmit 834 information to the endpoint device 812. The information can include, for example, the unique identifier or device ID 144 previously described above. The endpoint device 812 can then derive 836 a passcode for the gateway device 810 using the methods described above. In some implementations, the gateway device 810 only transmits 834 in response to entering 826 learn mode. In this regard, the information transmitted by the gateway device 810 is not publicly available for periods of time outside the learn mode, i.e., after the learn mode duration is expired. This reduces the ability for third party attackers to gain network access. Only with the gateway device 810 and endpoint device 812 in learn mode can the pairing process commence.

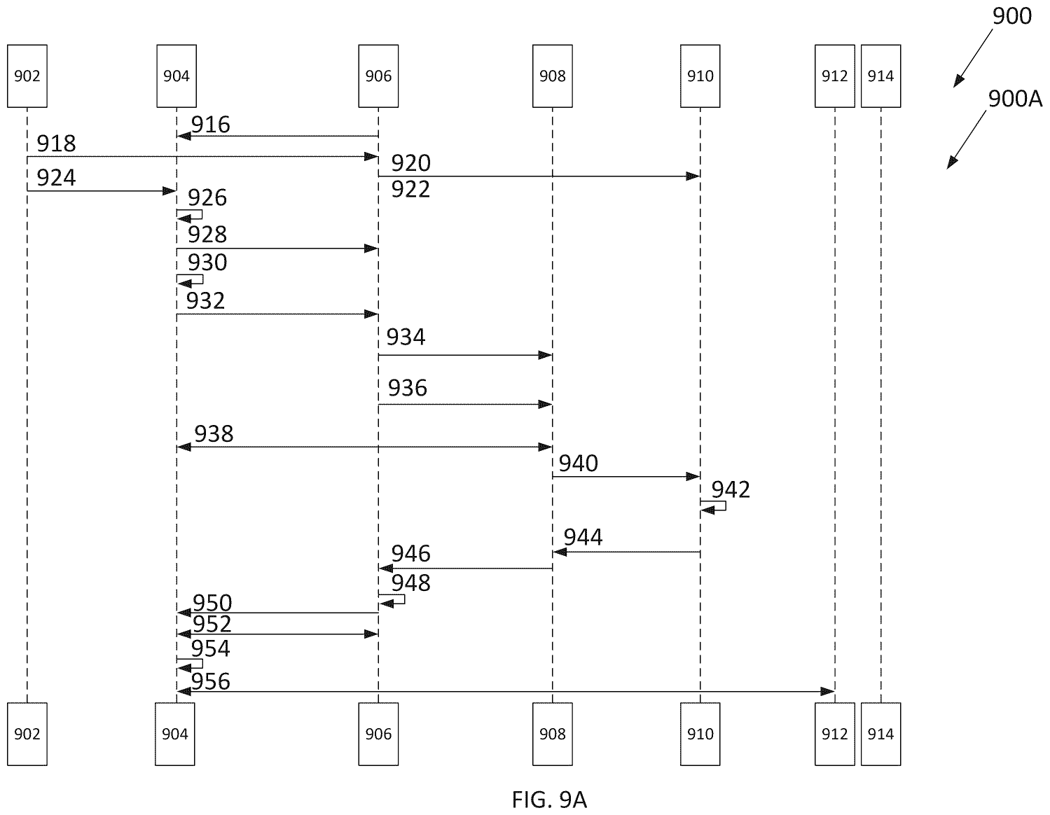

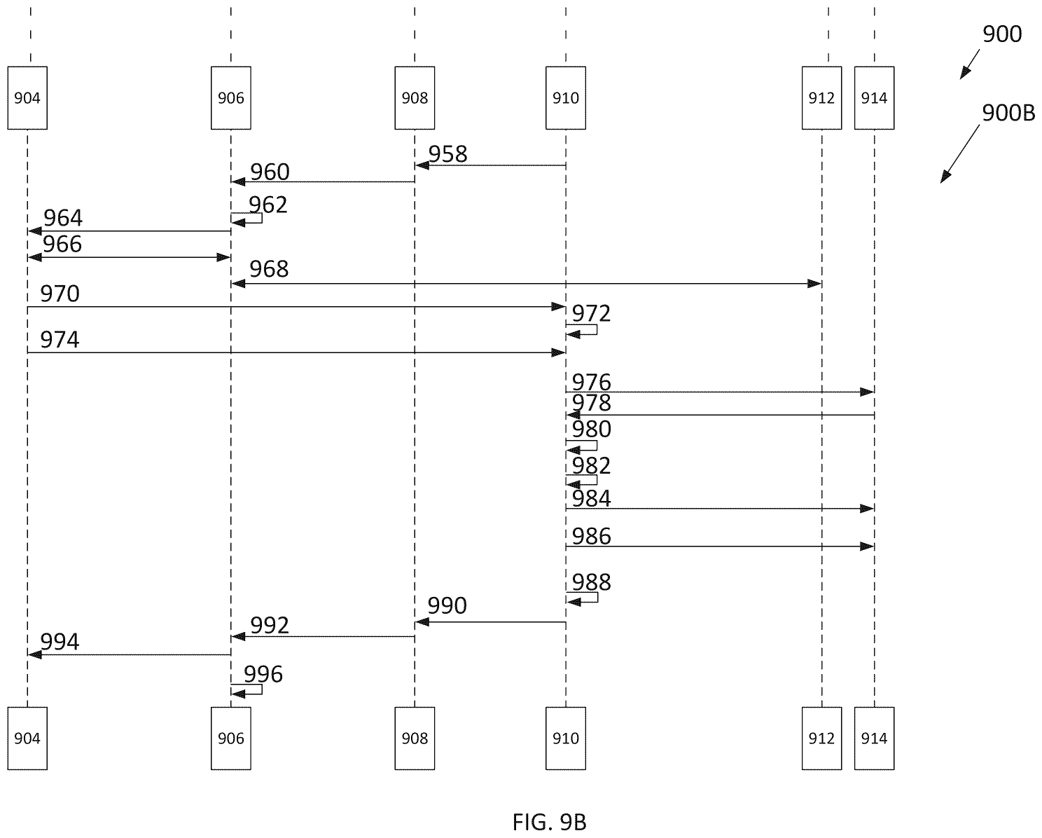

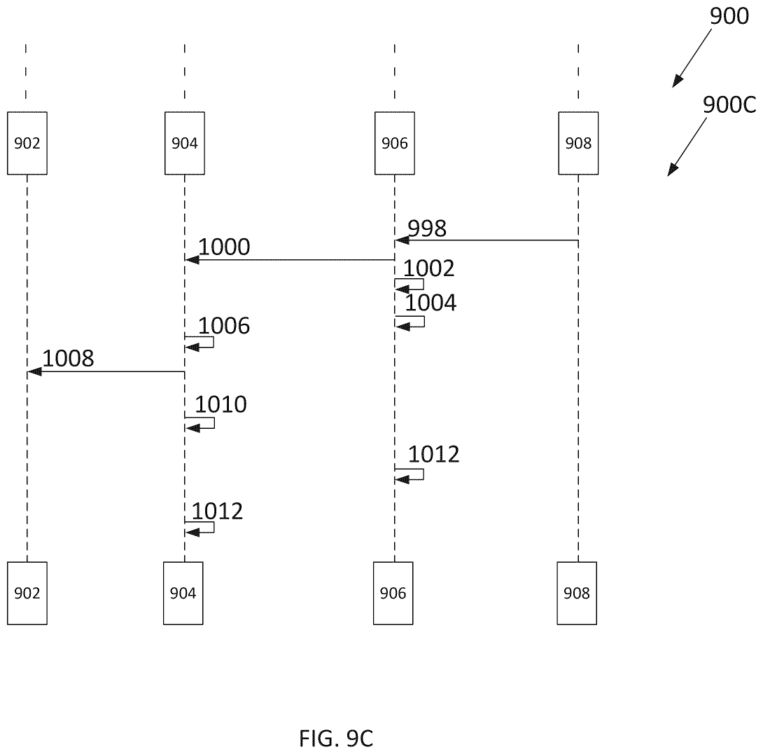

Once the endpoint device 812 successfully derives 836 the passcode, the gateway device 810 allows 838 the endpoint device 812 to connect to the gateway device 810. However, the gateway device 810 can continue denying internet access at such time. Internet/network access may be granted only after completion of a security layer as described below. The following embodiment describes an example security layer that may be implemented in the method 800. A further example security layer is discussed, for example, with reference to FIG. 9. It should be understood that the security layer may be modified to include additional steps, alternate steps, or steps from a different type of security layer. Moreover, in some instances, multiple security layers can be implemented, successively and/or in parallel with one another. Whereas the passcode derivation and resulting connection allow the endpoint device to quickly perform a handshake with the gateway device to gain connectivity therewith, limiting internet access until completion of the security layer promotes facility security, reducing the risk that a third party attacker can gain access to the facility and the goods stored therein.

In an embodiment, the security layer can include a mutual transport layer security (mTLS) layer 840 in which the gateway device 810 locally authenticates the endpoint device 812 and the endpoint device 812 locally authenticates the gateway device 810. Upon completing mutual authentication using mTLS, the devices 810, 812 have learned one another and internet access is granted to the endpoint device 812 through the gateway device 810.

The mTLS security layer 840 can include initiating 842 mTLS. In some implementation, mTLS is initiated 842 by the endpoint device 812 and received at the gateway device 810, however, initiating 842 of mTLS can occur from the gateway device 810 in other implementations. The other device, i.e., the gateway device 810, can request identity 844 from the endpoint device 812. The endpoint device 812 can respond 846 to the gateway device 810 with identifying information, such as a serial number of the endpoint device 812. The gateway device 810 can transmit an authorization request 848 to the endpoint device 812 which can respond 850 to acknowledge the authorization request 848. The gateway device 810 can then transmit 852 information such as a certification and a serial number and request endpoint device certification. The endpoint device 812, using the transmitted 852 information, or a portion thereof, can verify 854 the gateway device 810.

The method 800 further includes the endpoint device 812 responding 856 to the gateway device 810 with information such as a certification and a serial number of the endpoint device 812. The gateway device, using the information contained in the response 856, or a portion thereof, can verify 858 the endpoint device 812. The gateway device 810 can then request 860 termination of the security layer 840 to which the endpoint device 812 can respond 862, causing the security layer 840 to terminate. In some instances, the gateway device 810 can temporarily add 864 the endpoint device 812 to a whitelist accessible to the gateway device 810. In other instances, the gateway device 810 can permanently add 866 the endpoint device 812 to the whitelist.

The endpoint device 812 is then in communication with the remote server 806 and sends 868 a message to the remote server 806. The message can be transmitted through the gateway device 810. The message can indicate to the remote server 806 that the endpoint device 812 is online. In response, the remote server 806 can create and/or update 870 a record to indicate presence of the endpoint device 812. The facility person 808 can access 872 the remote server 806 and see the endpoint device 812 or information associated therewith as stored on the remote server 806.

In some implementations, the endpoint device 812 can be claimed, such as by the facility person 808, thereby linking the claimed endpoint device 812 to the facility. Claiming can include the facility person 808 becoming aware of an unclaimed device, such as a recently connected endpoint device 812. In some instances, the facility person 808 can receive a notification (such as an SMS message, a message from a remote server, an email, an equipment notification, or the like) that a new device is unclaimed that may be associated with the facility. For example, the remote server 806 can transmit a notification 874 to the facility person 808. Transmission of the notification 874 may occur after the gateway device 810 requests 860 termination of the security layer 840. The facility person 808 can interact 876 with the notification 874 or the remote server 806, such as through a user device, to claim the device. The remote server 806 can then transmit a message 878, such as an MQTT message, to the gateway device 810 to claim the endpoint device 812. The gateway device 810 can then add 880 the claimed status to a whitelist, such as a LAN whitelist. The endpoint device 812 can communicate with the remote server 882 periodically.

FIGS. 9A, 9B, and 9C illustrate a flow chart of an example method 900 of implementing the security layer for device validation. In particular, FIG. 9A illustrates a first portion 900A of the method 900, FIG. 9B illustrates a second portion 900B of the method 900, and FIG. 9C illustrates a third portion 900C of the method 900. The method 900 includes steps performed by various entities, including hardware, software, firmware, humans, and the like. The various entities can include, but are not limited to, an installer 902 (such as an original installation technician, a subsidiary installation technician, or a service technician), an endpoint device 904, a gateway device 906, a server such as a RADIUS server 908, a remote server 910, such as a manufacturer's server, a network 912, and a facility person 914. These various entities may be the same or different as compared to the entities described with respect to FIG. 8. Although FIG. 9 depicts steps performed in a particular order for purposes of illustration and discussion, the method discussed herein is not limited to any particular order or arrangement. One skilled in the art, using the disclosure provided herein, will appreciate that various steps of the method disclosed herein can be omitted, rearranged, combined, and/or adapted in various ways without deviating from the scope of the present disclosure. Moreover, while steps are depicted in FIGS. 9A, 9B, and 9C as abstractions, each step may include (encapsulate) a series of several messages exchanged between the participating entities.

The method 900 depicted in FIGS. 9A, 9B, and 9C permits a TLS exchange proxied through the gateway device 906. The endpoint device 904 can exchange EAP messages with the gateway device 906 which are translated to and from RADIUS format and forwarded to the RADIUS server 908 for processing. In some implementations, the RADIUS server 908 and the gateway device 906 can be co-located, e.g., the RADIUS server 908 can run on the gateway device 906. In other implementations, the RADIUS server 908 can be hosted on the internet, such as a cloud RADIUS.

The method 900 includes broadcasting 916, by the gateway device 906, information. The information can include, for example, the unique identifier or device ID 144 previously described above. In some instances, broadcasting 916 is fixed, occurring, for example, uninterrupted indefinitely or periodically. For fixed period broadcasts, broadcast duration and/or inter-broadcast duration may be adjustable. In other instances, broadcasting 916 is user-dependent, occurring, for example, in response to a person (e.g., the installer 902) activating a learn mode of the gateway device 906 located at or connected to the gateway device 906.

Upon activating 918 learn mode of the gateway device 906, the gateway device 906 can send 920 a learn mode start timestamp to the remote server 910. In one or more implementations, the sent 920 timestamp can transmitted MQTT. The remote server 910 can store and/or otherwise utilize the learn mode start timestamp. The gateway device 906 can also start 922 a learn mode timeout countdown, such as for example 60 seconds, two minutes, five minutes, ten minutes, etc. which, when expired, causes the gateway device 906 to exit learn mode. To reenter learn mode, the user must activate the learn mode, for example using a button or other-style user interface disposed at the gateway device 906 or electronically coupled therewith. In some instances, sending 902 the timestamp and starting 922 the learn mode timeout countdown can occur substantially simultaneously.

Prior to expiration of the learn mode timeout countdown, the installer 902 activates 924 learn mode on the endpoint device 904. The endpoint device 904 can capture 926 a learn mode timestamp, scan 928 for broadcast signals from a nearby gateway device, such as the aforementioned broadcasting 916 gateway device. The endpoint device 904 can build 930 a connection candidate list from scanned 928 gateway devices 906. Where multiple gateway devices 906 are detected, the endpoint device 904 can prioritize between the options captured in the connection candidate list based on one or more factors, such as RSSI threshold cutoff. Based on the prioritization, the endpoint device 904 can determine which option captured in the connection candidate list is best and select 932 said endpoint device 904 to connect with. The gateway device 906 can then communicate with the RADIUS server 908, for example, using a radsec proxy connection to tunnel with RADIUS traffic over TLS 934, or establish connection 936 to a local RADIUS server, for example, running on the hardware of the gateway device 906. The RADIUS server 908 can, in response to receiving the communication from the gateway device 906, initiate a handshake 938 with the endpoint device 904, such as an EAP-TLS handshake for mutual authentication. This handshake may include multiple exchanged messages. During and/or after the handshake 938, the RADIUS server 908 can query 940 access rules associated with the gateway device 906. The access rules may be accessible to the RADIUS server 908 from the remote server 910. The access rules can include, for example, endpoint identifying information. The remote server 910 can verify 942 the access rules, such as for example by looking up the site associated with the endpoint device 904, checking if the learn mode start timestamp for the gateway device 906 is within an allowed time window, or perform one or more other suitable actions.

The remote server 910 can then return 944 a message to the RADIUS server 908 indicating a result of the verification 942. For example, where the verification 942 indicates the endpoint device 904 is authorized access, the returned 944 message can include indication of said authorization. The RADIUS server 908 can then communicate 946 with the gateway device 906 to relay the authorization. In response, the gateway device 906 can grant access to the endpoint device 904, such as for example, by removing 948 port restrictions associated with the endpoint device 904. The gateway device 906 can further communicate 950 with the endpoint device 904 notifying the endpoint device 904 of successful authorization. Prior to and/or during the communication 950, the endpoint device 904 and gateway device 906 can initiate 952 intercommunication, including, e.g., Extensive Authentication Protocol over LAN (EAPOL) keying. The endpoint device 904 can save 954 information associated with the gateway device 906, e.g., to a whitelist or other form of local memory, e.g., non-volatile memory. Based on the saved 954 information, the endpoint device 904 can reconnect with the gateway device 906 without requiring the learn mode and associated steps described above, thus reducing labor required in the event the endpoint device 904 disconnects from the gateway device 906, such as during a power loss event. In some implementations, the endpoint device 904 can ping 956 the network 912 to gain access for full operation. For example, the endpoint device 904 can message the network 912 informing the network 912 of successful authorization and keying. The network 912 can grant network access to the endpoint device 904. Steps 944 to 956 may occur where the endpoint device 904 and gateway device 906 are pre-claimed by the facility. The following description replaces steps 944 to 956 when the endpoint device 904 is not pre-claimed by the facility.

When the endpoint device 904 is not pre-claimed by the facility, the remote server 910 can return 958 to the RADIUS server 908, in response to the verification 942 initiated by the remote server 910, a message indicating the result of the verification 942. For example, where the verification 942 indicates the endpoint device 904 is authorized access, the returned 958 message can include indication of said authorization. The returned 958 message can further signal that the authorization is restricted (e.g., VLAN restricted) based on the unclaimed status of the endpoint device 904. The RADIUS server 908 can then communicate 960 with the gateway device 906 to relay the authorization. In response, the gateway device 906 can grant access to the endpoint device 904, such as for example, by applying 962 a restricted VLAN assignment to the endpoint device 904. The gateway device 906 can further communicate 964 with the endpoint device 904 notifying the endpoint device 904 of successful authorization. Prior to and/or during the communication 964, the endpoint device 904 and gateway device 906 can initiate 966 intercommunication, including, e.g., Extensive Authentication Protocol over LAN (EAPOL) keying. The gateway device 906 can communicate 968 with the network 912 and information can be shared indicated restricted access of the endpoint device 904. Restricted access can be firewall enforced with no local internet access. The endpoint device 904, however, can be shared with the facility person 914 for claiming, a new device record can be generated, etc.

In many instances, the facility person 914 will want to claim the unclaimed endpoint device 904. By claiming the endpoint device 904, the facility person 914 and other people associated with the facility can easily observe and/or modify aspects of the endpoint device 904, e.g., using an application on a user device. For example, facility personnel can easily take the endpoint device 904 offline in the event of service or repair and re-online the endpoint device 904 after completion of the service or repair. To offline the endpoint device 904, the facility personnel can interact with the remote server 910, e.g., through the network 912. Facility personnel can further manage the endpoint device 904, such as for example, locking or unlocking certain functionality and capability associated with the endpoint device 904, connecting the endpoint device 904 to another gateway device 906, or the like. An example claiming operation will not be described in greater detail.

The endpoint device 904 can communicate 970 with the remote server 910. The communication 970 can include, for example, MQTTS or HTTPS received by the remote server 910. The remote server 910 can then create 972 a device record if one did not already exist. The endpoint device 904 can also send 974 the learn mode start timestamp to the remote server 910. Multiple methods exist for finalizing the claiming process. In one implementation, the remote server 910 can prompt 976 the facility person 914 to adopt the discovered device within the learn mode time window. After confirming 978, the remote server 910 can validate 980 learn mode time window for the endpoint device. In another implementation, the remote server 910 can add 982 the endpoint device 904 to the site and confirm 984 successful addition to the facility person 914. In yet another implementation, the remote server 910 can inform 986 the facility person 914 to refresh learn mode on the endpoint device 910. In some instances, the facility person 914 may receive a notification upon initializing the UI at a user device that provides the option to add all or select certain devices to claim. In some implementations, the facility person 914 may continue to receive the notification until claiming is completed. In other implementations, the facility person 914 may only receive the option to claim the device the initial time they initialize the UI at the user device. Upon finalizing the claiming process, the remote server 910 can automatically add 988 the endpoint device 904 to the same site as the gateway device 906.

In the event the endpoint device 904 is already claimed by another facility, where learn mode is disabled, the remote server 910 can reject 990 the connection and communicate the rejection to the RADIUS server 908 which can communicate 992 the access rejection to the gateway device 906. The gateway device 906 can notify the endpoint device 904 of EAP failure 994 and disassociate 996 the endpoint device 908.

In the event the authentication fails, for example the certification of the endpoint device 904 is not a genuinely recognized device, the RADIUS server 908 can reject the endpoint device 908 and transmit 998 the rejection to the gateway device 906. The gateway device 906 can notify 1000 the endpoint device 906 and deassociate 1002 the endpoint device 904. In some implementations, the gateway device 906 can further add the endpoint device 904 to a blacklist 1004, restricting the ability of the endpoint device 904 to connect to the gateway device 906 in the future. In some implementations, the endpoint device 904 can add the gateway device 906 to a blacklist 1006.

Once connection is established at the endpoint device 904, the endpoint device 904 can report 1008 connection results to the installer 902. In the event the endpoint device 904 fails to join the network 912 for any reason, the endpoint device 904 can retry 1010 connecting to another gateway device 906, such as the next option captured in the connection candidate list based on one or more factors, such as RSSI threshold cutoff. The process can repeat as described above with the next option. If the next option fails to connect, the endpoint device 904 can move to yet a further option captured in the connection candidate list, etc. until such time that the connection candidate list is exhausted.

In some implementations, after learn mode times out at the gateway device 906, the gateway device 906 can remove 1012 any unclaimed endpoint devices 904. In some implementations, after learn mode times out at the endpoint device 904, the endpoint device 904 stops 1014 trying to connect to a gateway device 906 to avoid possibility of an unclaimed device from connecting without user input.

Once the security layer is complete, the endpoint device is authorized to operate at the installed facility. The installer may simultaneously complete the security layer for two or more endpoint devices or serially authorize each endpoint device individually. As long as the gateway device is in learn mode, more than one endpoint device can be authorized. When the gateway device times out from the learn mode, the installer can reinitiate learn mode and continue authorizing endpoint devices. In some instances, the installer may be required to restart authorization once the learn mode times out. In other instances, the system may resume authorization from the previous point prior to learn mode timing out in response to the installer restarting learn mode.

Systems, methods, and components described herein permit easier installation of controllable devices at endpoint locations within environments, such as loading docks, by allowing the controllable devices to automatically access remote networks without a user manually entering network credentials. In such a manner, environments can be set up and retrofit faster with less human labor, thereby reducing set up costs and increasing set up efficiency.

Automatic access described herein refers to access by a controllable device and/or endpoint device to a network that does not require manually entry of login credentials to permit the controllable device and/or endpoint device to access the network. Automatic access may require a human to physically install the controllable device in an environment and couple the controllable device to a power source. In some implementations, automatic access may also require a human operator to further initiate network connection by instructing the controllable device or endpoint device to connect to the network. However, the endpoint device connects to the network without requiring the human operator to perform any further steps associated with the connection.

Use of a security layer after the endpoint device connects to the gateway device but prior to granting network access further enhances the automatic connection scheme by reducing the opportunity of a third party attacker to gain access to the gateway device, the endpoint device, or both. Dual authentication, and optionally claiming of the device by a facility person (such as a facility owner or manager), reduces the possibility of middle man attacks, thereby increasing facility security and reducing the risk of theft or other malicious activity. Further, claiming of the device by the facility person allows for quick setup and centralized control of the device without requiring manual entry or set up. That is, the facility person is presented with the option to claim the device as a result of the automated connection. For example, the device may appear on a local application running on a user device or facility hardware as a claimable device. The user may claim the device by accepting a prompted option. For example, a notification can appear on the user device indicating the presence of a claimable device and asking whether the claimable device should be claimed as part of the facility. This one-click functionality allows facility personnel to quickly onboard (claim) one or multiple endpoint devices downstream of their network connection process. In this regard, the installer initiates an automated process that results in complete onboarding of the device.

Further aspects of the invention are provided by one or more of the following embodiments:

Embodiment 1. A method of establishing network connection for an endpoint device, the method comprising: detecting, by an endpoint device comprising one or more processors, a gateway device in proximity to the endpoint device; receiving, at the endpoint device, a device ID of the gateway device; computing, by the endpoint device, a passcode prediction associated with the gateway device based on the device ID of the gateway device; and transmitting the passcode prediction to the gateway device to access a network.

Embodiment 2. The method of any one or more of the embodiments, wherein computing the passcode prediction comprises: determining, by the endpoint device, a passcode cipher based on one or more characteristics of the device ID, wherein the passcode cipher is part of a passcode cipher set; and computing, by the endpoint device, the passcode prediction based on the determined passcode cipher.

Embodiment 3. The method of any one or more of the embodiments, wherein determining the passcode cipher comprises: determining, by the endpoint device, the passcode cipher from the passcode cipher set using a cipher identifier; and providing, by the endpoint device, the passcode cipher for computing the passcode prediction.

Embodiment 4. The method of any one or more of the embodiments, wherein determining the passcode cipher using the cipher identifier is performed using a subset of the device ID, the subset including less than an entire device ID.

Embodiment 5. The method of any one or more of the embodiments, wherein detecting the gateway device comprises: detecting, by the endpoint device, two or more gateway devices; comparing, by the endpoint device, received signals associated with each of the two or more gateway devices; selecting, by the endpoint device, the gateway device from the two or more gateway devices based on the comparing.

Embodiment 6. The method of any one or more of the embodiments, wherein detecting the gateway device occurs in response to electrically connecting the one or more processors to a power source or in response to losing connection with the network.

Embodiment 7. The method of any one or more of the embodiments, further comprising implementing a security layer comprising a two-way validation protocol between the endpoint device and one or more of the gateway device, a local server, or a remote server, the two-way validation protocol comprising a local mTLS or an EAP authentication method.

Embodiment 8. The method of any one or more of the embodiments, further comprising receiving, at the endpoint device, a learn mode command prior to receiving the device ID of the gateway device.

Embodiment 9. A method of establishing network connection for an endpoint device, the method comprising: determining, by a gateway device communicatively connected to a network, a passcode for the gateway device based on a device ID of the gateway device; receiving, at the gateway device, a signal descriptive of a passcode prediction determined by an endpoint device; comparing, via the gateway device, the passcode determined by the gateway device and the passcode prediction of the endpoint device; and providing, via the gateway device, the endpoint device with access to the network based on the comparing.

Embodiment 10. The method of any one or more of the embodiments, further comprising storing the computed passcode in a memory of the gateway device, wherein comparing the passcode computed by the gateway device and the passcode prediction further comprises accessing the stored passcode from the memory.

Embodiment 11. The method of any one or more of the embodiments, further comprising implementing a security layer comprising a two-way validation protocol between the endpoint device and one or more of the gateway device, a local server, or a remote server, the two-way validation protocol comprising a local mTLS or an EAP authentication method.

Embodiment 12. The method of any one or more of the embodiments, further comprising: receiving, at the gateway device, credential information from the endpoint device, the credential information including an organizational unique identifier (OUI); comparing, via the gateway device, the received OUI and a whitelist of supported gateway devices; and terminating, via the gateway device, network access to the endpoint device based on the comparison.

Embodiment 13. The method of any one or more of the embodiments, wherein computing the passcode for the gateway device comprises: determining, by the gateway device, a passcode cipher based on one or more characteristics of the device ID; and determining, by the gateway device, the passcode based on the determined passcode cipher.

Embodiment 14. The method of any one or more of the embodiments, further comprising: receiving, at the gateway device, a request to change the passcode; determining, at the gateway device, a new passcode cipher based on the request; determining, at the gateway device, a new passcode based on the new passcode cipher.

Embodiment 15. The method of any one or more of the embodiments, further comprising: receiving, at the gateway device, a second signal descriptive of a passcode prediction determined by a second endpoint device; comparing, via the gateway device, the passcode computed by the gateway device and the passcode prediction determined by the second endpoint device; and providing, via the gateway device, the second endpoint device with access to the network based on the comparison.

Embodiment 16. A gateway device for establishing network connection for an endpoint device, the gateway device comprising: a network interface comprising one or more communication protocols configured to be communicatively coupled to a network; a local interface comprising a wireless communication protocol configured to be communicatively coupled to an endpoint device; a memory storing firmware including instructions configured to determine a passcode for the gateway device; and a processor configured to execute the instructions to: compute a passcode for the wireless communication protocol based on processing a device ID of the gateway device; perform a comparison between a received passcode prediction of the endpoint device and the passcode computed by the processor; and provide network access to the endpoint device based on the comparison.

Embodiment 17. The gateway device of any one or more of the embodiments, wherein the processor is configured to update the passcode in response to receiving a request to change the passcode.

Embodiment 18. The gateway device of any one or more of the embodiments, wherein the processor is configured to: receive credential information from the endpoint device, the credential information including an organizational unique identifier (OUI); compare the received OUI and a whitelist of supported endpoint devices; and terminate network access to the endpoint device based on a failed comparison.

Embodiment 19. The gateway of any one or more of the embodiments, wherein the endpoint device implements, with at least one of the gateway device, a local server, or a remote server, a security layer comprising a two-way validation protocol comprising a local mTLS or an EAP authentication method.

Embodiment 20. The gateway of any one or more of the embodiments, wherein the gateway device is disposed in an environment with the endpoint device, and wherein the endpoint device comprises a movable barrier operator.

The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. A method of establishing network connection for an endpoint device, the method comprising:
detecting, by an endpoint device comprising one or more processors, a gateway device in proximity to the endpoint device;
receiving, at the endpoint device, a device ID of the gateway device;
computing, by the endpoint device, a passcode prediction associated with the gateway device based on the device ID of the gateway device; and
transmitting the passcode prediction to the gateway device to access a network.

2. The method of claim 1, wherein computing the passcode prediction comprises:
determining, by the endpoint device, a passcode cipher based on one or more characteristics of the device ID, wherein the passcode cipher is part of a passcode cipher set; and
computing, by the endpoint device, the passcode prediction based on the determined passcode cipher.

3. The method of claim 2, wherein determining the passcode cipher comprises:
determining, by the endpoint device, the passcode cipher from the passcode cipher set using a cipher identifier; and
providing, by the endpoint device, the passcode cipher for computing the passcode prediction.

4. The method of claim 3, wherein determining the passcode cipher using the cipher identifier is performed using a subset of the device ID, the subset including less than an entire device ID.

5. The method of claim 1, wherein detecting the gateway device comprises:
detecting, by the endpoint device, two or more gateway devices;
comparing, by the endpoint device, received signals associated with each of the two or more gateway devices;
selecting, by the endpoint device, the gateway device from the two or more gateway devices based on the comparing.

6. The method of claim 1, wherein detecting the gateway device occurs in response to electrically connecting the one or more processors to a power source or in response to losing connection with the network.

7. The method of claim 1, further comprising implementing a security layer comprising a two-way validation protocol between the endpoint device and one or more of the gateway device, a local server, or a remote server, the two-way validation protocol comprising a local mTLS or an EAP authentication method.

8. The method of claim 1, further comprising receiving, at the endpoint device, a learn mode command prior to receiving the device ID of the gateway device.

9. A method of establishing network connection for an endpoint device, the method comprising:
determining, by a gateway device communicatively connected to a network, a passcode for the gateway device based on a device ID of the gateway device;
receiving, at the gateway device, a signal descriptive of a passcode prediction computed by an endpoint device;
comparing, via the gateway device, the passcode determined by the gateway device and the passcode prediction of the endpoint device; and
providing, via the gateway device, the endpoint device with access to the network based on the comparing.

10. The method of claim 9, further comprising storing the computed passcode in a memory of the gateway device, wherein comparing the passcode computed by the gateway device and the passcode prediction further comprises accessing the stored passcode from the memory.

11. The method of claim 9, further comprising implementing a security layer comprising a two-way validation protocol between the endpoint device and one or more of the gateway device, a local server, or a remote server, the two-way validation protocol comprising a local mTLS or an EAP authentication method.

12. The method of claim 9, further comprising:
receiving, at the gateway device, credential information from the endpoint device, the credential information including an organizational unique identifier (OUI);
comparing, via the gateway device, the received OUI and a whitelist of supported gateway devices; and
terminating, via the gateway device, network access to the endpoint device based on the comparison.

13. The method of claim 9, wherein computing the passcode for the gateway device comprises:
determining, by the gateway device, a passcode cipher based on one or more characteristics of the device ID; and
computing, by the gateway device, the passcode based on the determined passcode cipher.

14. The method of claim 13, further comprising:
receiving, at the gateway device, a request to change the passcode;
determining, at the gateway device, a new passcode cipher based on the request;
computing, at the gateway device, a new passcode based on the new passcode cipher.

15. The method of claim 9, further comprising:
receiving, at the gateway device, a second signal descriptive of a passcode prediction determined by a second endpoint device;
comparing, via the gateway device, the passcode computed by the gateway device and the passcode prediction determined by the second endpoint device; and
providing, via the gateway device, the second endpoint device with access to the network based on the comparison.

16. A gateway device for establishing network connection for an endpoint device, the gateway device comprising:
a network interface comprising one or more communication protocols configured to be communicatively coupled to a network;
a local interface comprising a wireless communication protocol configured to be communicatively coupled to an endpoint device;
a memory storing firmware including instructions configured to determine a passcode for the gateway device; and
a processor configured to execute the instructions to:
compute a passcode for the wireless communication protocol based on processing a device ID of the gateway device;
perform a comparison between a received passcode prediction of the endpoint device and the passcode computed by the processor; and
provide network access to the endpoint device based on the comparison.

17. The gateway device of claim 16, wherein the processor is configured to update the passcode in response to receiving a request to change the passcode.

18. The gateway device of claim 16, wherein the processor is configured to:
receive credential information from the endpoint device, the credential information including an organizational unique identifier (OUI);
compare the received OUI and a whitelist of supported endpoint devices; and
terminate network access to the endpoint device based on a failed comparison.

19. The gateway of claim 16, wherein the endpoint device implements, with at least one of the gateway device, a local server, or a remote server, a security layer comprising a two-way validation protocol comprising a local mTLS or an EAP authentication method.

20. The gateway of claim 16, wherein the gateway device is in an environment with the endpoint device, and wherein the endpoint device comprises a movable barrier operator.
